(19) United States
(12) Patent Application Publication
(10) Pub. No.: US 2017/0127471 A1
(43) Pub. Date: May 4, 2017

(54) RESOURCE RELEASE FOR PROXIMITY-BASED COMMUNICATIONS

(71) Applicant: Nokia Solutions and Networks Oy, Espoo (FI)

(72) Inventors: Ling Yu, Kauniainen (FI); Vinh Van Phan, Oulu (FI); Kari Veikko Horneman, Oulu (FI)

(21) Appl. No.: 15/127,154

(22) PCT Filed: Mar. 21, 2014
(86) PCT No.: PCT/EP2014/055726

§ 371 Date: Sep. 19, 2016

(51) Int. Cl. H04W 76/06; H04W 72/12

(52) U.S. Cl. CPC H04W 76/06; H04W 72/121; H04W 92/18

(57) ABSTRACT

An example technique may include controlling sending data by a first user device to a second user device in a network providing proximity-based services, determining, by the first user device, a release of a user plane protocol entity resources used for the proximity-based services in the second user device, and controlling sending, by the first user device to at least the second user device in response to the determining, a message that causes at least the second user device to perform the release of the user plane protocol entity resources used for the proximity-based services in the second user device.

### TECHNICAL FIELD

This description relates to communications networks.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

### SUMMARY

According to an example implementation, a method may include controlling sending data by a first user device to a second user device in a network providing proximity-based services, determining, by the first user device, a release of a user plane protocol entity resources used for the proximity-based services in the second user device, and controlling sending, by the first user device to at least the second user device in response to the determining, a message that causes at least the second user device to perform the release of the user plane protocol entity resources used for the proximity-based services in the second user device.

According to another example implementation, an apparatus includes at least one processor and at least one memory including computer instructions, when executed by the at least one processor, cause the apparatus to: control sending data by a first user device to a second user device in a network providing proximity-based services, determine, by the first user device, a release of a user plane protocol entity resources used for the proximity-based services in the second user device, and control sending, by the first user device to at least the second user device in response to the determining, a message that causes at least the second user device to perform the release of the user plane protocol entity resources used for the proximity-based services in the second user device.

According to another example implementation, a computer program product includes a computer-readable storage medium and storing executable code that, when executed by at least one data processing apparatus, is configured to cause the at least one data processing apparatus to perform a method comprising: controlling sending data by a first user device to a second user device in a network providing proximity-based services, determining, by the first user device, a release of a user plane protocol entity resources used for the proximity-based services in the second user device, and controlling sending, by the first user device to at least the second user device in response to the determining, a message that causes at least the second user device to perform the release of the user plane protocol entity resources used for the proximity-based services in the second user device.

According to another example implementation, an apparatus includes: means for controlling sending data by a first user device to a second user device in a network providing proximity-based services, means for determining, by the first user device, a release of a user plane protocol entity resources used for the proximity-based services in the second user device, and means for controlling sending, by the first user device to at least the second user device in response to the determining, a message that causes at least the second user device to perform the release of the user plane protocol entity resources used for the proximity-based services in the second user device.

According to another example implementation, a method includes controlling receiving data by a second user device from a first user device in a network providing proximity-based services, determining, by the second user device, a release of a user plane protocol entity resources used for the proximity-based services in the second user device, and performing, by the second user device, the release of the user plane protocol entity resources in the second user device.

According to another example implementation, an apparatus includes at least one processor and at least one memory including computer instructions, when executed by the at least one processor, cause the apparatus to: control receiving data by a second user device from a first user device in a network providing proximity-based services, determine, by the second user device, a release of a user plane protocol entity resources used for the proximity-based services in the second user device, and perform, by the second user device, the release of the user plane protocol entity resources in the second user device.

A computer program product includes a computer-readable storage medium and storing executable code that, when executed by at least one data processing apparatus, is configured to cause the at least one data processing apparatus to perform a method including: controlling receiving data by a second user device from a first user device in a network providing proximity-based services, determining, by the second user device, a release of a user plane protocol entity resources used for the proximity-based services in the second user device, and performing, by the second user device, the release of the user plane protocol entity resources in the second user device.

According to another example implementation, an apparatus may include: means for controlling receiving data by a second user device from a first user device in a network providing proximity-based services, determining, by the second user device, a release of a user plane protocol entity resources used for the proximity-based services in the second user device, and means for performing, by the second user device, the release of the user plane protocol entity resources in the second user device.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network 130 according to an example implementation.

FIG. 2 is a diagram illustrating an example implementation of a user device.

FIG. 3 is a signal diagram that illustrates signals and operations performed by user devices that may be used to cause a receiving user device to release UP protocol configurations (e.g., RLC entities and logical channels) according to an example implementation.

FIG. 4 is a flow chart illustrating operation of a user device according to an example implementation.

FIG. 5 is a flow chart illustrating operation of a user device according to an example implementation.

FIG. 6 is a block diagram of a wireless device (e.g., user device, BS or other wireless device) according to an example implementation.

### DETAILED DESCRIPTION

Various example implementations are provided relating to a release of a user plane (UP) protocol entity or user plane protocol entity resources, such as a radio link control (RLC) entity or radio link control entity resources, of a receiving user device that receives data from a transmitting user device in a network capable of providing proximity-based services, such as device-to-device (D2D) communications. A UP protocol configuration (or UP protocol entity resources), e.g., including a UP protocol entity and a logical channel, may be created or initiated (or configured) by the receiving user device to receive data from each transmitting D2D user device. Due to limited resources, e.g., due to a limited number of UP protocol entities/RLC entities that may be active at one time on a user device, various techniques may be used to detect UP protocol entity release conditions, and in some cases, sending a message from a transmitting user device to the receiving user device to cause the receiving user device to release a corresponding UP protocol entity (e.g., RLC entity).

According to an example implementation, a technique may include controlling sending data by a first user device to a second user device in a device-to-device (D2D) wireless network, the second user device including a user plane (UP) protocol entity (e.g., RLC entity) configured to receive data from the first user device, detecting, by the first user device, a condition, and controlling sending, by the first user device to the second user device in response to the detecting, a message that causes the second user device to release the UP protocol entity (e.g., RLC entity).

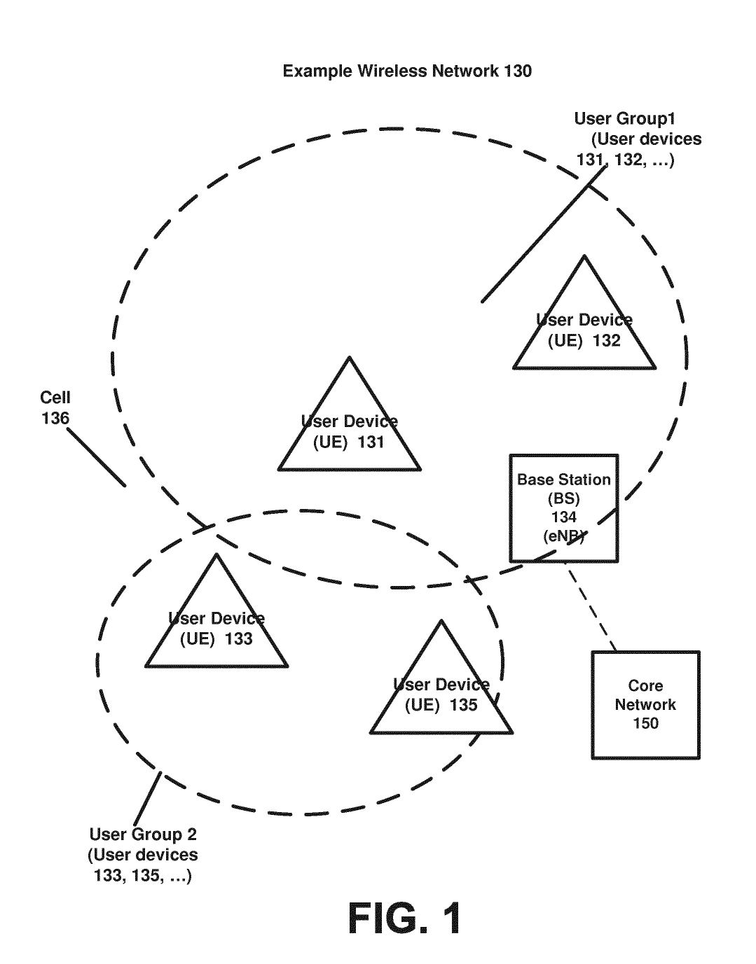

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B may be also be carried out by any node, server or host which may be operably coupled to a transceiver, such as a remote radio head. BS 134 provides wireless coverage within a cell 136. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE, core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

According to an example implementation, user devices 131,132, 133 and 135 may be in proximity to each other. User device 131 and 132 may be part of user group 1, while user devices 133 and 135 may be part of user group 2. One of the user devices, such as user device 131 may also operate as a multi-user group cluster head. A cluster head may transmit synchronization signals, and may also transmit a channel occupation (or channel occupancy) information for one or more channels including, for each channel, identifying whether the channel is free or occupied, and identify the user group that is occupying the channel and/or the user device ID of the user device that is occupying the channel if the channel is occupied, for example.

According to an example implementation, the user devices of user group 1 may operate in a device-to-device (D2D) mode in which user devices may directly communicate with each other. Similarly, the user devices for user group 2 may also operate in a D2D mode. Thus, in a D2D mode, communications may occur directly between user devices, rather than passing through BS 134, for example. D2D communications may be performed, for example, in the event of a breakage of S1 interface 151 or other network failure. Alternatively, a user group may be established and the user devices of such user group may perform D2D communications even when no such network failure has occurred, such as, for example, to offload traffic from the network (BS 134 and core network 150) and/or to allow user devices to communicate directly in a D2D mode.

According to an example implementation, one or more semi-persistent resources (e.g., wireless channel(s)) may be allocated, or made available for use, by the various user groups, including user group 1 and user group 2. Such resource or channel allocation may be considered persistent since it may be allocated to or occupied by a user group for an extended period of time (e.g., minutes) and does not typically expire, for example.

According to an example implementation, multiple user groups may share multiple resources (multiple wireless channels). Furthermore, according to an example implementation, once a channel has been obtained by or is occupied by a user group (or a user within the user group), then user devices within the occupying user group, e.g., when operating in a D2D mode of operation, may use/share the channel up to a group channel holding period. Also, within a group channel holding period for a channel, user devices within an occupying user group (that occupies the channel) may hold or occupy the channel up to a user channel holding period. A group channel holding period (e.g., minutes) may be much longer than a user channel holding period (e.g., tens or hundreds or milliseconds). Therefore, according to an example implementation, once a user device obtains a free or available channel, the user device obtains the channel for itself (up to a user channel holding period) and also obtains the channel on behalf of (or for) its user group (e.g., allowing users of that user group to occupy or hold the channel up to a group channel holding period). Because of the shared nature of such resource or channel, when one user device is transmitting, 1 or more (or even all) of the other user devices within the same user group and even other user devices within other user groups may receive the transmitted signal via the shared channel. Thus, such a transmission may be considered as a broadcast transmission, or a 1:M transmission in the D2D mode.

According to one example implementation, a distributed resource allocation technique may be used, where user devices may contend for the right to occupy or hold the channel. A variety of distributed resource access techniques may be used, such as contention-based access techniques where user devices contend for the right to control the channel or the right to transmit on the channel. One example of a distributed resource access technique that may be used may include a Carrier Sense Multiple Access (CSMA) technique in which a node or user device first senses the channel or medium to determine if another node or user device is transmitting. If the channel is idle, the user device may begin transmitting. If the channel or medium is busy, the user device waits for the channel to become idle. Thus, CSMA may be employ a listen-before-talk or sense-before-transmit technique for user devices to contend for the right to transmit a packet. A number of CSMA variations may be employed, for example, such as a CSMA/collision detection (CSMA/CD) in which performance may be improved by a user device terminating its transmission on the channel as soon as a collision is detected. A CSMA/collision avoidance (CSMA/CA) technique may be used where, for example, a user device may first transmit a request to send (RTS), and then either detect idle channel or wait for a clear to send (CTS) signal, before transmitting on the channel. If the channel is busy, or if no CTS signal is received, then the user device may wait or back-off a random period of time, before sensing the channel and transmitting if channel is idle or upon receipt of a CTS signal. These are just a few example distributed resource allocation techniques, and any resource allocation technique may be used by a user device to obtain control of a channel (or obtain the right to transmit on the channel).

According to an example implementation, as noted above, a channel may be divided into group channel holding periods that allow user devices of a group to share or use the channel within such group channel holding period. Each group channel holding period may include multiple (or a plurality of) user channel holding periods where a user device may hold or occupy the channel. According to an example implementation, holding or occupying the channel by a user device may allow the holding user device to transmit data and control signals on the channel, schedule resources for contention windows to allow other user devices to contend to transmit data or signals, and otherwise control the channel for the user channel holding period. For example, once a user device obtains (or holds) the shared channel, the (holding) user device may transmit data via the channel to other user devices. The user device that holds the channel may also schedule opportunities or windows during its channel holding period that allow one or more other user devices of the user group to transmit (or contend for the right to transmit) during the channel holding period, for example.

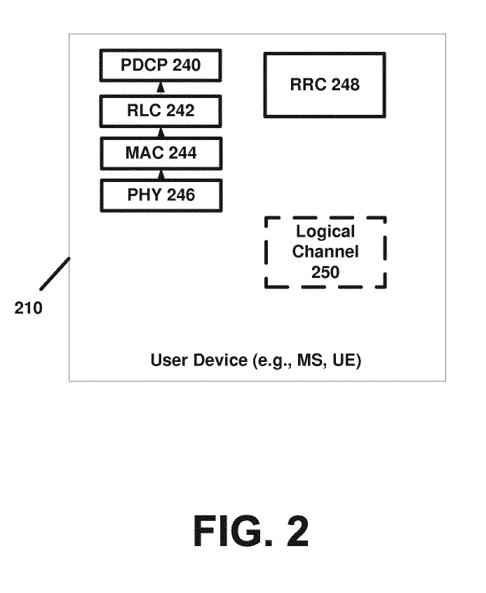

FIG. 2 is a diagram illustrating an example implementation of a user device. Each user device may include at least one radio protocol stack that may be implemented in hardware and/or software. According to an example implementation, a protocol stack may include logic, and/or computer instructions executed by a processor to perform the functions or operations for each entity of the protocol stack. An example protocol stack for a user device 210 may include, for example, a Packet Data Convergence Protocol (PDCP) entity 240, a Radio Link Control (RLC) entity 242, a Media Access Control (MAC) entity 244, a Physical layer (PHY) entity 246, and a Radio Resource Control (RRC) entity 248.

The PDCP entity 240 may, for example, perform ciphering (encryption and decryption of data) and header compression-decompression. The RLC entity 242 may, for example, perform segmentation/concatenation, error detection and correction, data retransmission, duplicate detection and in-sequence data delivery to higher layers. According to an example implementation, there may be one RLC corresponding to one logical channel MAC entity 244 performs multiplexing of logical channels (where there may be one or more logical channels), hybrid ARQ retransmissions, inserting of MAC control elements (MAC CEs) used for in-band control signaling, and other MAC-related functions. The PHY entity 246 handles or performs coding/decoding, modulation/demodulation, multi-antenna mapping, and other physical layer functions. Multiple RLC entities within a user device may share one MAC entity 244 and one PHY entity 246.

RRC entity 248 may be responsible for handling a number of functions or procedures related to the Radio Access Network (RAN).

According to an example implementation, one or more user devices may operate in a 1:M D2D mode in which the user devices may communicate directly with each other. In an example 1:M D2D mode of operation, a transmitting user device may broadcast data via a shared wireless channel to a plurality (M) of other user devices that are also operating in a D2D mode. A user device may have multiple applications that may be transmitting data in a D2D mode of operation. According to an example implementation, at a transmitting user device, a user plane (UP) protocol configuration may be initiated or configured (e.g., by the RRC entity 248) for each application that is transmitting data. User plane entities may, for example, include one or more entities at a user device that are involved in transmitting data to and/or receiving data from other user devices. For example, a user device may include multiple transmitting applications including, for example, a voice application (e.g., voice over LTE or VoLTE) to transmit voice data, and a texting or messaging application to transmit text data. These are merely two examples, and other applications may be used or provided.

According to an example implementation, a UP protocol configuration may be configured or initiated for each application that is transmitting data on a user device operating in a D2D mode of operation to other user devices. According to an example implementation, a UP protocol configuration may include one or more UP protocol entities, such as a RLC entity 242 and/or a PDCP entity 240, and a logical channel 250. For example, at a transmitting user device in D2D mode, a first RLC entity and a first logical channel may be initiated or configured for a voice application to transmit voice data, while a second RLC entity and a second logical channel may be initiated or configured for a messaging application to transmit messaging-related data. In various example implementations, a PDCP entity may be provided for each RLC entity, or a PDCP entity may not necessarily be used for D2D communications, in the above-described example involving a voice application and a messaging application.

According to an example implementation, a user device operating in a D2D mode that is receiving data from one or more applications (which may be referred to as a receiving user device) of one or more other D2D user devices may include a UP protocol entity to receive data from each transmitting application. In one example implementation, a UP protocol configuration does not necessarily need to be created or initiated in advance by a receiving user device, but may be initiated or configured based upon receipt of data from another D2D user device.

For example, a first application of a first user device (operating in D2D mode) may be transmitting data to a plurality of D2D user devices, including to a second user device. The MAC entity of the (receiving) second user device may receive a MAC protocol data unit (PDU) from the first user device, and decodes the MAC PDU. The MAC PDU may include, for example, a source ID that includes a user device identifier (user device ID), a destination ID (which may be set to a user group ID, of which the second user device is a member), and a logical channel ID to identify a logical channel for the data (e.g., where a different logical channel may be used for each application that is transmitting data from a user device). Based on the source ID (identifying the transmitting user device) and the logical channel ID (e.g., LCID) in the MAC PDU, the MAC entity 244 of the receiving user device may determine if a UP protocol configuration has already been initiated or configured for this source ID/LCID combination. If this is a first MAC PDU for the source ID/LCID (e.g., no UP protocol configuration has yet been initiated or configured for such source ID/LCID), then the MAC entity 244 on the receiving user device sends an indication to the RRC entity 248 on the receiving user device. In response to receiving this indication, the RRC entity 248 of the receiving user device may initiate or configure a UP protocol configuration for this source ID/LCID, e.g., including a PDCP entity 240, a RLC entity 242 and a logical channel 250, for example. In another example implementation, the RRC entity 248 of the receiving user device may configure or initiate a UP protocol configuration that includes only a RLC entity 242 and a logical channel 250. Thus, for example, a receiving user device may create or include a separate RLC entity and logical channel for each user device that is transmitting data (e.g., a user device may include a separate RLC entity and logical channel to receive data from an application of a transmitting D2D user device).

As noted above, according to one example implementation, the MAC PDU received by the receiving user device may include data, a source ID that identifies the transmitting user device, a destination ID that may identify a receiving user device or a user group of which the receiving user device is a member, and a logical channel ID (LCID) that identifies the logical channel. In another example implementation, one or more of the source ID, destination ID and/or LCID are not necessarily included within the MAC PDU or data packet, but may be provided via separate signal(s) or message(s). For example, a transmitting user device may obtain a D2D channel holding period, and may then transmit a scheduling announcement to identify resources that will be used to transmit the data to one or more receiving user devices. In an example implementation, the source ID, destination ID and/or the LCID may be transmitted by the transmitting user device in the scheduling announcement or scheduling announcement, or one or more of the source ID, destination ID and/or LCID may be previously associated with the channel or channel holding period that the transmitting user has obtained. Thus, in such a case, it may be unnecessary for the transmitting user device to transmit the source ID, destination ID and/or LCID within the transmitted data packet or MAC PDU, for example. Also, in another example implementation, this information may be sent using a combination of these two approaches, e.g., one or more of this information or fields (source ID, destination ID, LCID) may be provided within a scheduling announcement or scheduling announcement and one or more remaining fields or information may be provided via the data packet or MAC PDU sent from the transmitting user device.

However, resources at each D2D user device are finite or limited. For example, a user device may be able to maintain only a threshold or maximum number of RLC entities at a time. For example, a user device may be able to create or maintain only eight RLC entities concurrently. The number eight is merely an example, and is used for illustrative purposes. Thus, if a D2D user device is receiving data from both voice and data applications of each of four other user devices (requiring 8 RLC entities at the receiving user device), then the receiving user device may be precluded from establishing an RLC entity to receive data from another application or transmitting user device until the receiving user device first releases one of its RLC entities. Similarly, a user device may have a limit of the number of RLC entities that may be created or maintained concurrently, for either transmitting or receiving. Therefore, it may be desirable for a user device to selectively initiate (or configure) and release UP protocol entities (e.g., RLC entities).

A transmitting user device may typically know when to release a UP protocol configuration (e.g., RLC entity and logical channel) that it is using to transmit data. For example, the application may end or terminate a session between the transmitting user device and the other receiving user devices, e.g., when the voice (or VoLTE) call is ended. Thus, the application may notify the RRC entity 248 of a transmitting user device, and the RRC entity 248 may then release the RLC entity 242 and the logical channel 250 that were being used by the transmitting user device to transmit the data. However, in some cases, it may be less clear when a receiving user device should release a UP protocol configuration (e.g., RLC entity and logical channel) for a session.

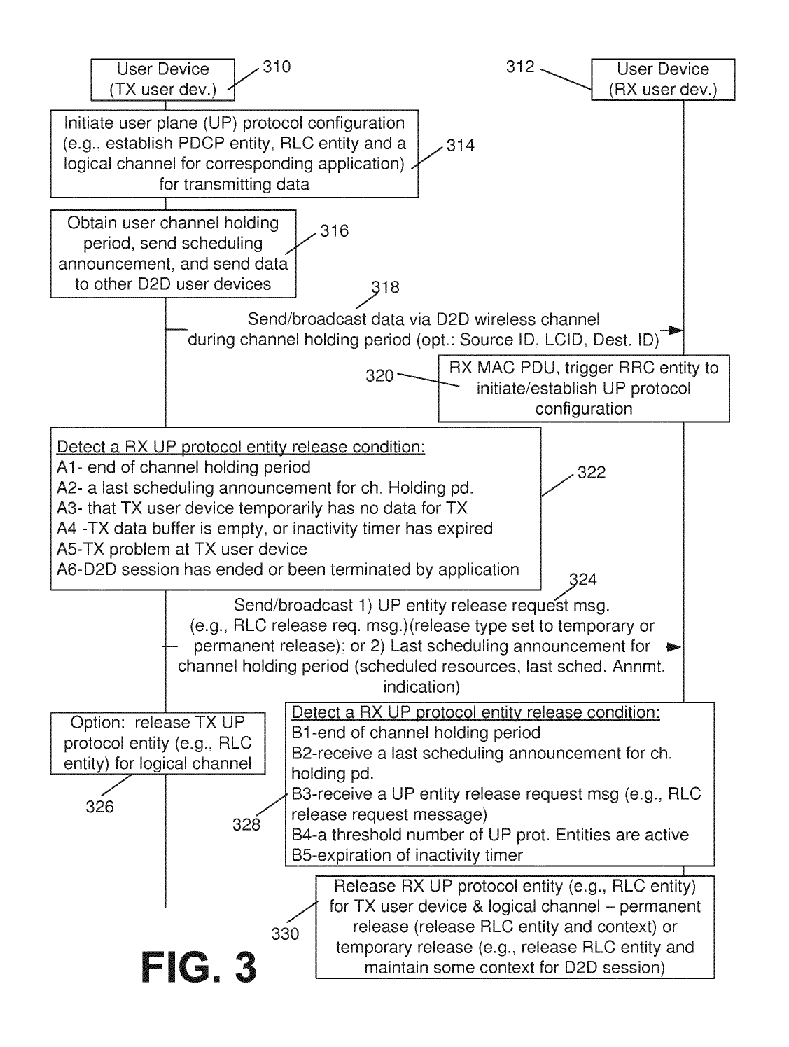

FIG. 3 is a signal diagram that illustrates signals and operations performed by user devices that may be used to cause a receiving user device to release UP protocol configurations (e.g., RLC entities and logical channels) according to an example implementation. Referring to FIG. 3, a user device 310 may be an example transmitting user device, e.g., which includes one or more applications transmitting to one or more user devices. A user device 312 may be one of several receiving user devices, e.g., which receives data from the transmitting user device 310. Both transmitting user device 310 and receiving user device 312 may be operating in a D2D mode of operation.

At 314, in one illustrative example, an application running or executing on user device 310 may be opened or initiated on user device 310 with data to be sent. In response, RRC entity or other entity on user device 310 may initiate or configure a user plane (UP) protocol configuration (or UP protocol entity resources), which may include a PDCP entity, a RLC entity and a logical channel for use by an application (e.g., voice application, messaging application or other application) for sending or transmitting data. Alternatively, the UP protocol configuration may include a RLC entity and a logical channel for use by the application on transmitting user device 310 for transmitting or sending data to one or more other use devices, such as receiving user device 312.

At 316, the user device 310 may obtain a channel holding period (e.g., a user channel holding period) for a wireless channel, and send a scheduling announcement via the wireless channel during the channel holding period to identify resources that will be used for transmission of data. As noted above, according to one example implementation, one or more of a source ID, destination ID and/or a LCID may be included in the scheduling announcement, or in other control signal(s). At 316 and 318, the transmitting user device 310 sends data to one or more other user devices (including to user device 312) via the identified resources. The data sent by user device 310 at 316 may use the initiated or configured UP protocol entity resources, e.g., the RLC entity and logical channel that were initiated or configured at 314. The data may be received as a MAC protocol data unit (PDU) and decoded by a MAC entity of the receiving user device 312. In addition to data, the MAC PDU may optionally include one or more fields, including, for example, a source ID identifying the source of the MAC PDU (e.g., a user ID identifying the transmitting user device 310), a destination ID identifying a destination of the MAC PDU (e.g., a user group address to which the data is directed to or addressed to), and a logical channel ID or LCID that identifies the logical channel for the transmitted data. A different logical channel (or LCID) may be assigned to each application on a transmitting user device to transmit data, e.g., a first LCID may be assigned to a voice application, a second LCID may be assigned to a messaging application on the same user device. For example, the transmitting user device 310 may correspond to (or be identified by) the source ID, and the receiving user device 312 may correspond to the destination ID (e.g., device 312 may be identified by destination ID or be a member of a D2D user group that is identified by destination ID).

At 320, the MAC entity of receiving user device 312 determines, based on the source ID/LCID of the received MAC PDU, whether the MAC PDU is for an existing UP protocol configuration (e.g., RLC entity and logical channel), or whether such MAC PDU is a first data for a new application and source user device (e.g., requiring the creation of a new corresponding new RLC entity and logical channel to receive such data). The source ID, destination ID and LCID for the MAC PDU are not necessarily included within the MAC PDU. Rather, as noted, the source ID, LCID and/or destination ID may be provided via signaling, such as within a scheduling announcement sent or transmitted by transmitting user device 310, for example. The source ID may identify the transmitting user device 310 (e.g., identifying the source of the MAC PDU), while the destination ID may identify the receiving user device 312 or a user group of which the receiving user device 312 is a member (e.g., identifying a destination of the MAC PDU). If the received MAC PDU is from a new application/transmitting user device, then the MAC entity of the receiving user device 312 may send an indication to the RRC entity of the receiving user device 312. The RRC entity of the receiving user device 312 may create or initiate (or configure) a new UP protocol configuration, e.g., a new PDCP entity, a new RLC entity and new logical channel for receiving the data from the corresponding application and transmitting user device 310.

At 322, the transmitting user device 310 may detect a UP protocol entity release condition for a receiving user device (e.g., for receiving user device 312), e.g., where the transmitting user device 310 may instruct the receiving user device 312 to release its corresponding UP protocol entity (e.g., corresponding RLC entity) and the corresponding logical connection at the receiving user device. As shown at 322, a number of different conditions may be detected by transmitting user device 310 which may cause the transmitting user device 310 to transmit a message to the receiving user device that causes the receiving user device 312 to release a UP protocol entity (e.g., RLC entity) and logical connection created or initiated (or configured) to receive data from the transmitting user device 310.

There may be a plurality of example UP protocol entity release conditions for a receiving user device. In response to detecting (at 322) a UP protocol entity release condition, a message may be sent (at 324) from the transmitting user device 310 to the receiving user device 312 to cause the receiving user device to release the UP protocol entity (e.g., RLC entity) and logical channel. Each of these example conditions (listed at 322) will be briefly described, along with a short description of a message that may be sent at 324 to cause the receiving user device to release the UP protocol entity, e.g., RLC entity. At 322, the UP protocol entity release conditions for a receiving user device may include, for example:

A1) Detecting an end of a channel holding period. The transmission of data by a transmitting user device 310 may at least be temporarily stopped when the user device 310 loses the channel holding period, and the transmission of data from the user device 310 may be resumed when the user device re-obtains the channel during a subsequent channel holding period. In such a case, the transmitting user device may send a release message, which may also be referred to as a UP entity release request message (e.g., RLC release request message) at 324 that may include, for example, one or more fields such as a release indication (indicating or instructing receiving user device 312 to release UP protocol entity resources) and a release type indicating permanent release or temporary release. The release message at 324 may optionally includes one or more additional fields, such as a source ID, a LCID and a destination ID. Although, one or more of these fields (source ID, LCID and destination ID) may be communicated to the receiving user device 312 via separate signaling, such as being provided in a scheduling announcement or other signaling, for example. Thus, the data within the MAC PDU is transmitted from the transmitting user device 310 to the receiving user device 310 via a channel and this data or MAC PDU may be associated with a source ID, destination ID and LCID by providing these fields directly in the MAC PDU or within other signaling or messages also transmitted via the same channel, according to an example implementation.

As noted, the release type in the release message may indicate permanent release or a temporary release. A permanent release of a UP protocol entity, e.g., permanent release of a RLC entity, for example, may include a release of the RLC entity (allowing the RLC entity be re-assigned or re-used) and logical channel and a release (or deletion) of any context information (e.g., source ID, LCID, sequence number of last received packet or MAC PDU for this session and/or other context information) for the session associated with the RLC entity. According to an example implementation, a temporary release of the UP protocol entity (e.g., release of the RLC entity) may include releasing the RLC entity and logical channel, while maintaining or storing at least some of the context information for the session associated with the UP protocol entity or RLC entity.

A2) Identifying a last scheduling announcement of a channel holding period. This indicates an end of a channel holding period. Thus, the transmitting user device 310 may send or broadcast either 1) a UP entity release request message (e.g., RLC release request message) as describe with reference to A1, or 2) a scheduling announcement that announces resources to be used to transmit data from the transmitting user device 310 to the receiving user device 312, including a last scheduled announcement indication indicating that the scheduling announcement is a last scheduling announcement for the channel holding period. This scheduling announcement, indicating a last scheduling announcement for the channel holding period, may cause the receiving user device 312 to temporarily release the UP protocol entity (e.g., RLC entity) and logical channel (e.g., while optionally storing context information for the associated session). Thus, according to an example implementation, a scheduling announcement that is the last scheduling announcement for the channel holding period may be handled or processed by the receiving user device 312 in the same or a similar manner as a UP entity (or RLC entity) release request message indicating temporary release.

The last scheduling announcement may be used an implicit UP protocol entity resource release request to one or more receiving user devices. For example, a transmitting user device 310, upon identifying the last scheduling announcement (SA) to be sent/broadcast, it may include a last SA indication in the SA. Upon receiving/detecting the last SA with last SA indication, the receiving user device 312 may perform a temporary release of associated UP protocol entity resources (e.g., RLC entity and logical channel) after receiving all the data that are scheduled by the last scheduling announcement. In such case, an explicit UP entity release message may be unnecessary since the last SA may be used to cause the receiving user devices to release their associated UP protocol entity resources after receiving last scheduled data for the channel holding period.

A3) Detecting that the transmitting user device 310 temporarily has no data to send; or A4) Detecting that a transmission buffer of the transmitting user device 310 is empty or that an inactivity timer of the transmitting user device 310 has expired for lack of transmission activity by the transmitting user device 310; or A5) Detecting a transmission problem at the transmitting user device 310. If any of conditions A3-A5 have been detected or determined, then the transmitting user device 310 may, for example, send a UP entity release request message (or RLC entity release request message) to the receiving user device(s) 312, e.g., indicating or requesting the receiving user device 312 to perform a temporary release of the UP protocol entity/RLC entity. Thus, for example, the UP entity release message (or simply release message) may include a release indication instructing the receiving user devices to release the associated UP entities, and a release type indicating either temporary release or permanent release.

A6) Detecting that the D2D session between the application of the transmitting user device 310 and the receiving user device 312 has ended or been terminated. In case that condition A6 has been detected by the transmitting user device 310, the transmitting user device 310 may send a UP entity release message (or RLC entity release message) to the receiving user device 312, e.g., indicating or requesting the receiving user device 312 to perform a permanent release of the UP entity resources. For example, in this case, there may be no need to store or maintain the context for this session or call if the session has been terminated.

At 324, as noted above, the transmitting user device 310 may send to the receiving user device either 1) a UP entity release message (which may be referred to as a release message) indicating either temporary or permanent release of associated UP entity resources (e.g., RLC entity and logical channel), or 2) a last scheduling announcement (SA) indicating that the scheduling announcement is a last scheduling announcement for a channel holding period. As noted, in some cases, the last SA may operate as an implicit release message to one or more receiving user devices.

At 326, the transmitting user device 310 device may similarly release a UP protocol entity or RLC entity, and/or logical channel, e.g., depending on availability of RLC entity resources and demand for RLC entities at (or by) the transmitting user device 310.

At 328, there may be one or more UP entity resource release conditions that may be detected by the receiving user device. Some of these conditions may be the same as or similar to one or more conditions described at 322, or may be different conditions. At 328, these UP protocol entity release (e.g., RLC release request) conditions may include, for example:

B1) Detecting an end of a channel holding period. The receiving user device 312 may detect an end of a channel holding period based on, for example, the current time and a schedule of the channel holding periods that indicates an end of the channel holding period, or by the receiving user device receiving a message from the transmitting user device indicating the end of the channel holding period. In response to condition B1, the receiving user device 312 may release a UP protocol (e.g., RLC) entity for receiving data from an application of the transmitting user device or associated with the session. The release of the UP protocol entity or RLC entity may be permanent or temporary.

B2) Receiving a last scheduling announcement indicating that the scheduling announcement is the last scheduling announcement of the channel holding period, which may typically cause the receiving user device at 330 to temporarily release the UP protocol entity (e.g., RLC entity) and logical channel after receiving the data that are scheduled by the scheduling announcement.

B3)—Receiving a UP entity (e.g., RLC entity) release request message by the receiving user device from the transmitting user device. This message may cause the receiving user device at 330 to release the UP protocol entity or RLC entity, either permanently or temporarily, depending on what type of release may have been indicated by the release request message.

B4)—Detecting that a threshold (e.g., a maximum) number of UP protocol (e.g., RLC) entities are active or in use by the receiving user device 312. When this is detected by the receiving user device, this may cause the receiving user device 312 to release a UP protocol or RLC entity e.g. for the application with lower priority, as needed.

B5) Expiration of inactivity timer (a timer-based release condition). According to one example implementation, at the receiving user device 312, an inactivity timer may be set and reset to a timer-value whenever data (e.g., MAC PDU) is received by the MAC entity of the receiving user device 312, for example. For example, the receiving user device may release its UP entity resources (e.g., RLC entity and logical channel) associated with the session or the transmitting user device and logical channel when the inactivity timer expires. Thus, the expiration of the inactivity timer provides an indication that no data have been received by the receiving user device 312 from this transmitting user device/logical channel in a timer-value period of time. Thus, due to this inactivity of this logical channel, the UP entity resources at the receiving user device 312 may be released, either temporarily or permanently, to allow these UP entity resources to be re-allocated to other transmitting user devices/logical channels.

According to another example implementation, features B4) and B5) may be used together. In an example implementation, a longer timer-value for inactivity timer(s) may be used when there are fewer initiated or configured UP entity resources at the receiving user device, and a shorter timer-value may be used when there are more initiated or configured UP entity resources. This allows the user device to be more patient in releasing UP entity resources (with a longer timer-value) when less than the threshold or maximum number of UP entity resources have been configured, and to more quickly release and reallocate UP entity resources (via shorter timer-value).

According to one illustrative example, there may be a maximum of 8 UP entities (e.g., 8 RLC entities and 8 logical channels) available to be initiated or configured by either a receiving user device or a transmitting user device (or a user device that may be both transmitting and receiving). For example, initially, when a first RLC entity and logical channel are configured, then a first timer-value, e.g., 200 ms timer-value, may be used for the associated inactivity timer. This 200 ms timer-value may be used up to a first threshold of active or configured UP entity resources, e.g., up to 3 active or configured RLC entities. When 4 or more RLC entities, up to 7 RLC entities, have been initiated or configured, then a second timer-value, e.g., 100 ms, which is shorter than the first timer-value may be used for all inactivity timers. Finally, when 8 (or the maximum or threshold number) of RLC entities have been initiated or configured by a user device, then a third timer-value, e.g., 50 ms, which is shorter than the second timer-value, may be used for any configured inactivity timers. Similarly, the timer-value may be increased as UP entity resources are released, e.g., back to using the second timer value if between 4 and 7 RLC entities have been configured or are active, and then back to using the first timer-value if less than 4 RLC entities have been configured or are active. This is merely an example, and any numbers may be used.

According to yet another variation or another alternative implementation, instead of using one timer-value for all inactivity timers of a user device, different timer-values may be used according to priority of the associated session, e.g., priority-based timer-values. For example, a first (high) timer-value may (e.g., 200 ms) be used for a timer-value for an inactivity timer for a high priority session; a second (middle) timer-value (e.g., 100 ms), shorter than the first timer value, may be used for sessions or calls having middle range priority, lower priority than the high priority sessions; and a third timer-value (e.g., 50 ms), less than the second timer-value, may be used for low priority sessions or calls. These priority-based timer values may also be adjusted or scaled based on condition B4, e.g., based on the number of active or configured UP entity resources at a user device. For example, a first set of priority-based timer values of 200 ms, 100 ms, and 50 ms may be used when there are less than 4 active or configured UP entity resources, a second set of priority-based timer-values (having values lower than respective values of first set), e.g., 100 ms, 50 ms, and 25 ms, may be used if there are more than 4 and less than 8 active UP entity resources, and a third (even lower) set of priority-based timer-values, e.g., 50 ms, 25 ms, and 10 ms, may be used if there are 8 (or maximum) UP entity resources that are active or configured for a user device.

At 330, the receiving user device may release a UP protocol entity or UP entity resources (e.g., RLC entity and logical channel) based on a condition that may be detected (at 322) by a transmitting user device 310 and signaled (at 324) to the receiving user device and/or based on the receiving user device 312 detecting a condition at 328.

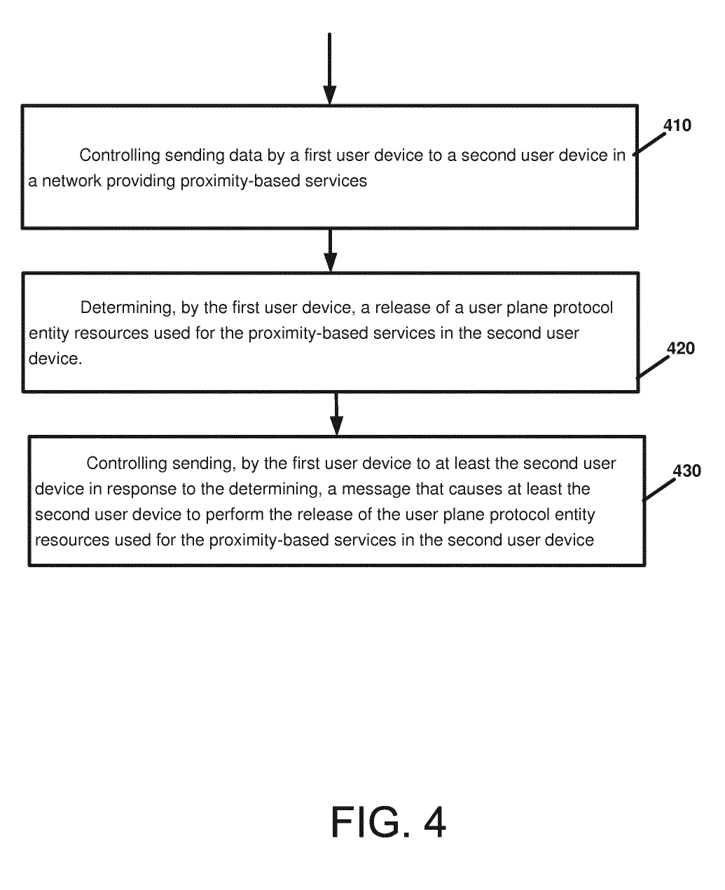

FIG. 4 is a flow chart illustrating operation of a user device according to an example implementation. Operation 410 may include controlling sending data by a first user device to a second user device in a network providing proximity-based services. Operation 420 may include determining, by the first user device, a release of a user plane protocol entity resources used for the proximity-based services in the second user device. Operation 430 may include controlling sending, by the first user device to at least the second user device in response to the determining, a message that causes at least the second user device to perform the release of the user plane protocol entity resources used for the proximity-based services in the second user device. According to an example implementation of the method described in FIG. 4, the first user device occupies or holds a channel holding period, and wherein the determining may include detecting, by the first user device, an end of the channel holding period.

According to an example implementation of the method described in FIG. 4, the determining may include determining, by the first user device, that the first user device temporarily has no data to send to the second user device.

According to an example implementation of the method described in FIG. 4, the determining may include determining, by the first user device that a transmission data buffer for the first user device is empty or an inactivity timer for the first user device has expired.

According to an example implementation of the method described in FIG. 4, the determining may include determining, by the first user device, that a transmission problem has occurred at the first user device.

According to an example implementation of the method described in FIG. 4, the determining may include determining, by the first user device that a D2D session, from the first user device to one or more other user devices including the second user device, has ended or been terminated.

According to an example implementation of the method described in FIG. 4, the controlling sending data by the first user device may include obtaining, by the first user device, a channel holding period for a wireless channel of the D2D wireless network, controlling sending, by the first user device, a scheduling announcement via the wireless channel to identify resources that will be used to transmit data via the wireless channel during the channel holding period, wherein the scheduling announcement includes information indicating that the scheduling announcement is a last scheduling announcement for the channel holding period, and controlling sending the data from the first user device to at least the second user device via the resources identified by the scheduling announcement.

According to an example implementation of the method described in FIG. 4, the determining may include determining by the first user device, that the scheduling announcement is a last scheduling announcement for the channel holding period.

According to an example implementation of the method described in FIG. 4, the controlling sending a message may include controlling sending, from the first user device to at least the second user device, a scheduling announcement that identifies resources of a channel holding period of a wireless channel for transmission of data from the first user device to at least the second user device, wherein the scheduling announcement includes information indicating that the scheduling announcement is a last scheduling announcement within the channel holding period.

According to an example implementation of the method described in FIG. 4, the controlling sending a message may include controlling sending, from the first user device to at least the second user device, a RLC release request message requesting that the second user device release the RLC entity, the RLC release request message including a release type identifying either a temporary release or a permanent release.

According to an example implementation of the method described in FIG. 4, the message may include a source field identifying the first user device, a destination field identifying a D2D or proximity services user group of which the second user device is a member, and a release type identifying either a temporary release or a permanent release.

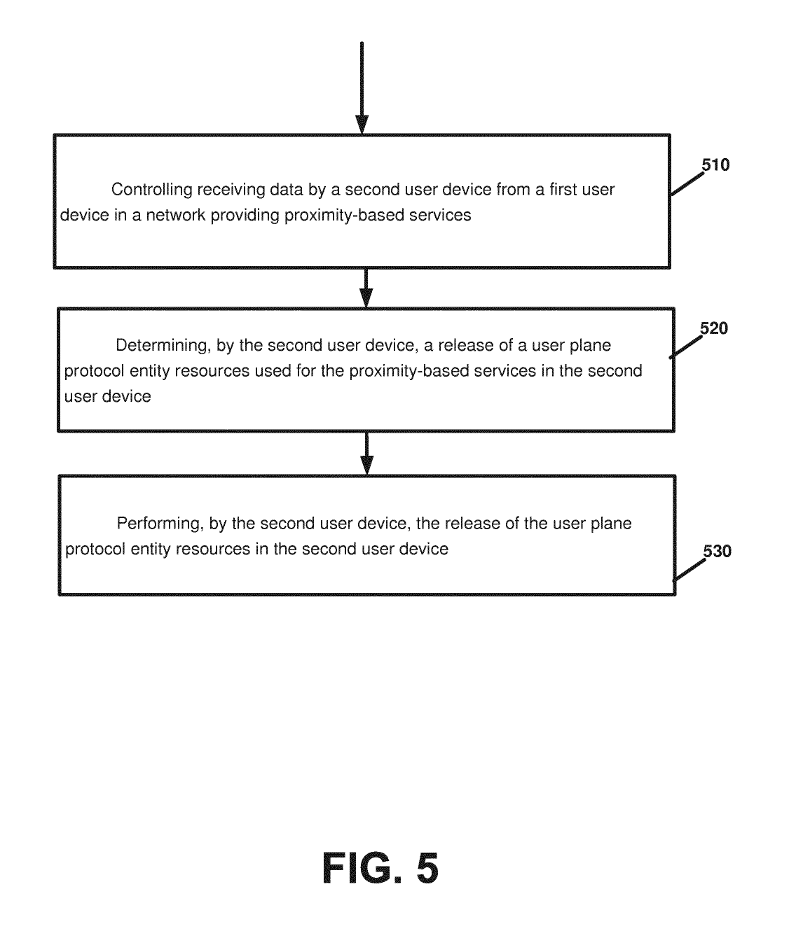

FIG. 5 is a flow chart illustrating operation of a user device according to another example implementation. Operation 510 may include controlling receiving data by a second user device from a first user device in a network providing proximity-based services. Operation 520 may include determining, by the second user device, a release of a user plane protocol entity resources used for the proximity-based services in the second user device. Operation 530 may include performing, by the second user device, the release of the user plane protocol entity resources in the second user device.

According to an example implementation of the method described in FIG. 5, the user plane protocol entity resources may include at least one of the following: a radio link control entity, a radio link control unacknowledged mode entity, a packet data convergence protocol entity, and a logical channel.

According to an example implementation of the method described in FIG. 5, the determining a release may include performing at least one of the following: determining an end of a channel holding period that was occupied by the first user device, determining that a predetermined number of user plane protocol entity resources have been initiated or configured by the second user device, determining an expiration of an inactivity timer for the second user device, receiving, by the second user device, a last scheduling announcement from the first user device, receiving, by the second user device from the first user device, a release message instructing the second user device to release the user plane protocol entity resources, and receiving, by the second user device from the first user device, a last scheduling announcement indicating a last scheduling announcement within a channel holding period occupied by the first user device.

According to an example implementation of the method described in FIG. 5, the user plane protocol entity may include a radio link control entity and wherein the determining may include controlling receiving, by the second user device from the first user device, a release message requesting a release of the radio link control entity used for the proximity-based services.

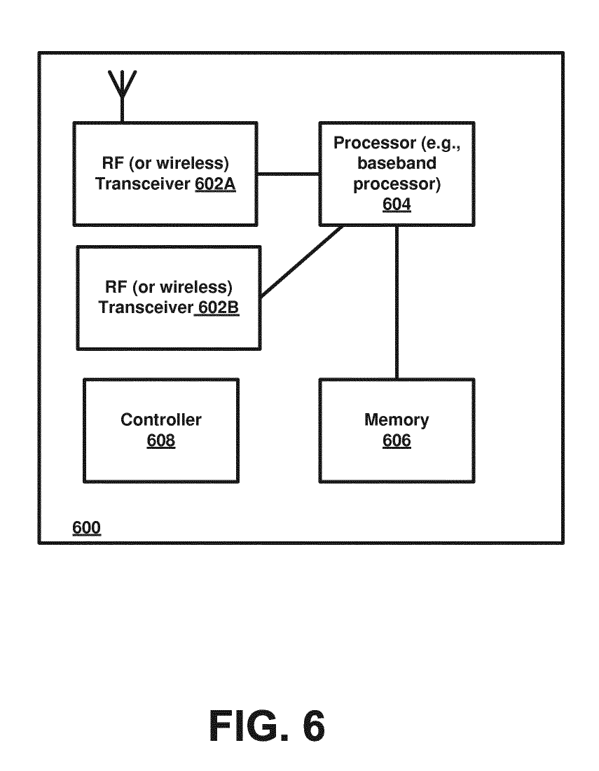

FIG. 6 is a block diagram of a wireless station (e.g., BS or user device) 600 according to an example implementation. The wireless station 600 may include, for example, two RF (radio frequency) or wireless transceivers 602A, 602B, where each wireless transceiver includes a transmitter to transmit signals and a receiver to receive signals. The wireless station also includes a processor or control unit/entity (controller) 604 to execute instructions or software and control transmission and receptions of signals, and a memory 606 to store data and/or instructions.

Processor 604 may also make decisions or determinations, generate frames, packets or messages for transmission, decode received frames or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6, such as controlling input/output devices (e.g., display, keypad), and/or may execute software for one or more applications that may be provided on wireless station 600, such as, for example, an email program, audio/video applications, a word processor, a Voice over IP application, or other application or software.

In addition, a storage medium may be provided that includes stored instructions, which when executed by a controller or processor may result in the processor 604, or other controller or processor, performing one or more of the functions or tasks described above.

According to another example implementation, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

Another example of an apparatus may include means (604, 602A, 602B) for controlling sending data by a first user device to a second user device in a network providing proximity-based service, means (604) for determining, by the first user device, a release of a user plane protocol entity resources used for the proximity-based services in the second user device, and means (604, 602A, 602B) for controlling sending, by the first user device to at least the second user device in response to the determining, a message that causes at least the second user device to perform the release of the user plane protocol entity resources used for the proximity-based services in the second user device.

Another example of an apparatus may include means (604, 602A, 602B) for controlling receiving data by a second user device from a first user device in a network providing proximity-based services, means for determining (604), by the second user device, a release of a user plane protocol entity resources used for the proximity-based services in the second user device, and means (604, 602A, 602B) for performing, by the second user device, the release of the user plane protocol entity resources in the second user device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT) or cyber physical systems.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Further more, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-44. (canceled)

45. A method comprising:
controlling sending data by a first user device to a second user device in a network providing proximity-based services;
determining, by the first user device, a release of a user plane protocol entity resources used for the proximity-based services in the second user device; and
controlling sending, by the first user device to at least the second user device in response to the determining, a message that causes at least the second user device to perform the release of the user plane protocol entity resources used for the proximity-based services in the second user device.

46. The method of claim 45, wherein the user plane protocol entity resources used for the proximity-based services in the second user device comprise at least one of the following:
a radio link control entity in the second user device that is used to receive data from the first user device,
a radio link control entity and a logical channel in the second user device that are used to receive data from the first user device, and
a packet data convergence protocol entity and a radio link control entity in the second user device that are used to receive data from the first user device.

47. The method of claim 45, wherein the controlling sending comprises controlling sending a release message instructing the second user device to release the user plane protocol entity resources.

48. The method of claim 45, wherein the user plane protocol entity resources comprise the user plane protocol entity resources at the second user device used to receive data from the first user device, wherein the controlling sending comprises controlling sending a release message that includes a release type indication that indicates either a temporary release of the user plane protocol entity resources, or a permanent release of the user plane protocol entity resources.

49. The method of claim 45, wherein the determining comprises determining, by the first user device, at least one of the following:
that the first user device temporarily has no data to send to the second user device;
that a transmission data buffer for the first user device is empty or an inactivity timer for the first user device has expired;
that a transmission problem has occurred at the first user device; and
that a providing a proximity-based services session, from the first user device to one or more other user devices including the second user device, has ended or been terminated.

50. The method of claim 45, wherein the controlling sending a message comprises at least one of the following:
controlling sending, from the first user device to at least the second user device, a scheduling announcement that identifies resources of a channel holding period of a wireless channel for transmission of data from the first user device to at least the second user device, wherein the scheduling announcement includes information indicating that the scheduling announcement is a last scheduling announcement within the channel holding period; and
controlling sending, from the first user device to at least the second user device, a release request message requesting that the second user device releases at least one of the following: a radio link control entity, radio link control unacknowledged mode entity, packet data convergence protocol entity and a logical channel.

51. The method of claim 45, wherein the message comprises:
a source field identifying the first user device;
a destination field identifying a proximity-based services user group of which the second user device is a member; and
a release type identifying either a temporary release or a permanent release.

52. An apparatus comprising at least one processor and at least one memory including computer instructions, when executed by the at least one processor, cause the apparatus to:
control sending data by a first user device to a second user device in a network providing proximity-based services;
determine, by the first user device, a release of a user plane protocol entity resources used for the proximity-based services in the second user device; and
control sending, by the first user device to at least the second user device in response to the determining, a message that causes at least the second user device to perform the release of the user plane protocol entity resources used for the proximity-based services in the second user device.

53. The apparatus of claim 52, wherein the user plane protocol entity resources used for the proximity-based services in the second user device comprise at least one of the following:
a radio link control entity in the second user device that is used to receive data from the first user device,
a radio link control entity and a logical channel in the second user device that are used to receive data from the first user device, and
a packet data convergence protocol entity and a radio link control entity in the second user device that are used to receive data from the first user device.

54. The apparatus of claim 52, wherein the instructions that cause the apparatus to control sending comprises instructions that cause the apparatus to control sending a release message instructing the second user device to release the user plane protocol entity resources.

55. The apparatus of claim 52, wherein the user plane protocol entity resources comprise the user plane protocol entity resources at the second user device used to receive data from the first user device, wherein the controlling sending comprises controlling sending a release message that includes a release type indication that indicates either a temporary release of the user plane protocol entity resources, or a permanent release of the user plane protocol entity resources.

56. The apparatus of claim 52, wherein the instructions that cause the apparatus to control sending comprises instructions that cause the apparatus to control sending, from the first user device to at least the second user device, a scheduling announcement that identifies resources of a channel holding period of a wireless channel for transmission of data from the first user device to at least the second user device, wherein the scheduling announcement includes information indicating that the scheduling announcement is a last scheduling announcement within the channel holding period.

57. The apparatus of claim 52, wherein the message is a release request message requesting that the second user device releases at least one of the following: a radio link control entity, radio link control unacknowledged mode entity, packet data convergence protocol entity and a logical channel.

58. The apparatus of claim 52, wherein the message comprises:
a source field identifying the first user device;
a destination field identifying a proximity-based services user group of which the second user device is a member; and
a release type identifying either a temporary release or a permanent release.

59. An apparatus comprising at least one processor and at least one memory including computer instructions, when executed by the at least one processor, cause the apparatus to:
control receiving data by a second user device from a first user device in a network providing proximity-based services;
determine, by the second user device, a release of a user plane protocol entity resources used for the proximity-based services in the second user device, and
perform, by the second user device, the release of the user plane protocol entity resources in the second user device.

60. The apparatus of claim 59, wherein the user plane protocol entity resources comprise at least one of the following: a radio link control entity, a radio link control unacknowledged mode entity, a packet data convergence protocol entity, and a logical channel.

61. The apparatus of claim 59, wherein the user plane protocol entity comprises a radio link control entity and wherein the instructions that cause the apparatus to determine comprises instructions that cause the apparatus to control receiving, by the second user device from the first user device, a release message requesting a release of the radio link control entity used for the proximity-based services.

62. The apparatus of claim 59, wherein the determining comprises controlling receiving, by the second user device from the first user device, a release message requesting a release of at least one of the following: a radio link control entity,
radio link control entity unacknowledged mode entity, packet data convergence protocol entity and a logical channel.
